(19) United States
(12) Patent Application Publication
(10) Pub. No.: US 2024/0258545 A1
(43) Pub. Date: Aug. 1, 2024

(54) TREATMENT OF HYDROGEN- AND OXYGEN-CONTAINING RESIDUAL GASES OF FUEL CELLS

(71) Applicant: Siemens Energy Global GmbH & Co. KG, München (DE)

(72) Inventors: Fabian Straub, Hessdorf (DE); Michael Braunecker, Nürnberg (DE); Torsten Brandt

(21) Appl. No.: 18/292,363

(22) PCT Filed: Jul. 11, 2022
(86) PCT No.: PCT/EP2022/069251

§ 371 Date: Jan. 26, 2024

(30) Foreign Application Priority Data
Jul. 28, 2021 (DE) 10 2021 208 146.0

(51) Int. Cl. H01M 8/0662; H01M 8/04537; H01M 8/2457

(52) U.S. Cl. CPC H01M 8/0662; H01M 8/04567; H01M 8/04597; H01M 8/2457

(57) ABSTRACT

The invention relates to a fuel cell assembly having a plurality of fuel cells amalgamated electrically and mechanically in a fuel cell stack, further including a residual gas treatment device for hydrogen-containing and oxygen-containing residual gases of the fuel cells, wherein the residual gas treatment device includes a recombination fuel cell with catalyst and membrane that is led via a power circuit separate from the fuel cells, and to a method for treating hydrogen-containing and oxygen-containing residual gases from fuel cells.

### BACKGROUND

The invention relates to a fuel cell assembly with fuel cells and a residual gas treatment device for hydrogen-containing and oxygen-containing residual gases of the fuel cells, and to a method for treating hydrogen-containing and oxygen-containing residual gases from fuel cells.

Fuel cells, fuel cell assemblies with a plurality of fuel cells, and methods for operating them are extensively known in the art. Fuel cells are electrochemical cells in which a chemical reaction, more particularly an exergonic chemical reaction, of at least two reaction gases releases energy which the cells provide at least partly as electrical energy. Fuel cells therefore serve purposes including that of electrical energy supply but also, in certain circumstances, of thermal energy supply.

One use of fuel cells is in stationary applications, allowing the provision, for example, of uninterrupted energy supply, microgrids and/or the like. Furthermore, heat energy for heating purposes may also be provided using fuel cells.

Additionally, fuel cells are also used with vehicles, examples being watercraft such as ferries or submarines, aircraft, and motor vehicles as well, especially with vehicles that may be electrically propelled such as, for example, electric vehicles, hybrid vehicles or the like.

Another frequent intention is to utilize fuel cells to improve the travel range of vehicles that may be electrically propelled, where fuel cells are provided as an addition or an alternative to the use of a respective vehicle battery for the electrical energy supply of an electrical propulsion facility in the vehicle.

One kind of fuel cell frequently used is the hydrogen-oxygen fuel cell, in which an electrochemical reaction of hydrogen and oxygen usually generates electrical energy and heat. The supply of oxygen may also be replaced or supplemented by air, according to the construction of the fuel cell. Water is a product of the reaction. Furthermore, there are corresponding residual gases to be discharged from the fuel cell in the region of the respective electrode—for example, a hydrogen-containing residual gas at the electrode serving as anode, and an oxygen-containing residual gas at the electrode serving as cathode.

In regular operation of the hydrogen-oxygen fuel cell, hydrogen is supplied to the anode, whereas oxygen is supplied to the cathode. The electrodes are in electrochemical interaction with one another via an electrolyte, which may be formed, for example, by a polymer electrolyte membrane or the like. The supplying of the hydrogen may be realized either through a pure hydrogen gas or else through a hydrogen-containing fuel gas. Similarly, the supplying of the oxygen may be realized through pure oxygen gas or else, for example, in the form of air.

With a hydrogen-oxygen fuel cell of this kind, a direct-current voltage is usually provided between the electrodes and may amount for example to about 1 V or less. Typically, therefore, a plurality of fuel cells are operated electrically in series connection and may be amalgamated to form a fuel cell stack of a fuel cell assembly.

In the operation of fuel cells, unreacted residual gases arise at the outlet. These gases, normally, are emitted to the surroundings. In the case of a polymer electrolyte fuel cell, they constitute hydrogen-containing residual gas and oxygen-containing residual gas. If the fuel cell is required to operate in a closed system, the residual gases must be separately stored. In order to permit safe separate storage, the hydrogen content in the residual gases must be reduced below the explosion limit, or ideally avoided entirely.

Non-operated modules may contain hydrogen on the oxygen side as well, if, for example, the gas spaces have been charged with hydrogen in order to prevent corrosion and oxidation.

While the fuel cell is indeed first purged with nitrogen before entering into operation, it is nevertheless possible for “new oxygen” to meet “old hydrogen” on the oxygen side and to react with it, in which case thermal energy may be released in quantities which may damage the fuel cell(s).

Excess hydrogen may therefore often be consumed by downstream reaction with the aid of existing oxygen, using what are called catalytic burners or recombiners. These catalytic burners or recombiners are separate components.

A method for treating hydrogen-containing and oxygen-containing residual gases from fuel cells, and a residual gas treatment system, are disclosed for example by WO 2020/038907 A1. The teaching of WO 2020/038907 A1 is particularly suitable for the substantially closed operation of a fuel cell assembly, where the residual gases are not to be simply emitted to the surroundings—for example, an ambient atmosphere or the like. Although this teaching is established, there are nevertheless disadvantages apparent. Particularly when the operating state of the fuel cell is changed, and especially during operations of switching on and switching off the fuel cell, the residual gas mixture in the residual gas circuit may develop an unwanted gas composition, which may affect optimal utilization according to the teaching of WO 2020/038907 A1.

### SUMMARY

In one embodiment, a fuel cell assembly is provided. The fuel cell assembly includes a plurality of fuel cells amalgamated electrically and mechanically in a fuel cell stack, further including a residual gas treatment device for hydrogen-containing and oxygen-containing residual gases of the fuel cells, characterized in that the residual gas treatment device comprises a recombination fuel cell with catalyst and membrane that is led via a power circuit separate from the fuel cells.

In one embodiment, a method for treating hydrogen-containing and oxygen-containing residual gases from fuel cells is provided. The residual gases from fuel cells amalgamated electrically and mechanically in a fuel cell stack are supplied to a recombination fuel cell which is led via a power circuit separate from the fuel cells.

### DETAILED DESCRIPTION

The object on which the invention is based is therefore that of providing a fuel cell assembly with fuel cells and a residual gas treatment device for hydrogen-containing and oxygen-containing residual gases of the fuel cells, and a method for treating hydrogen-containing and oxygen-containing residual gases from fuel cells, in order to allow largely optimal residual gas treatment to be realized.

As a solution, the invention proposes a fuel cell assembly with fuel cells and a residual gas treatment device for hydrogen-containing and oxygen-containing residual gases of the fuel cells, and a method for treating hydrogen-containing and oxygen-containing residual gases from fuel cells, according to the independent claims.

Advantageous developments are apparent through features of the dependent claims.

The invention achieves the object directed to a fuel cell assembly by stipulating that in such a fuel cell assembly, comprising a plurality of fuel cells amalgamated electrically and mechanically in a fuel cell stack, further comprising a residual gas treatment device for hydrogen-containing and oxygen-containing residual gases of the fuel cells, the residual gas treatment device comprises a recombination fuel cell with catalyst and membrane that is led via a power circuit separate from the fuel cells.

The construction of the fuel cell assembly is extended to include one or more so-called recombination cells. These fuel cells are normal cells with catalyst and membrane, as employed in the fuel cell assembly. The residual gases formed are led into the recombination fuel cell, where they are reacted electrochemically to give water. The recombination fuel cell is led via a power circuit separate from the rest of the fuel cells.

In one embodiment of the invention, the recombination fuel cell is directly downstream of the fuel cells in the fuel cell stack, which permits a compact construction.

In an alternative embodiment, the recombination fuel cell is arranged outside the fuel cell stack. In this case, the existing fuel cell stack can remain unaltered.

It is advantageous if a measuring device for voltage and/or current is integrated into the recombination fuel cell or connected to the recombination fuel cell. This makes it possible to measure the conversion of hydrogen in the residual gas and in the best case to provide information on the quantity of hydrogen at the exit of the recombination cell.

In a further embodiment of the invention, a metal-sheet recombination cell is arranged between the fuel cells and the recombination fuel cell, the membrane of the recombination fuel cell being replaced in the metal-sheet recombination cell by a metal sheet. The metal sheet in the middle of the cell makes this metal-sheet recombination cell more mechanically and thermally stable. Because of the direct reaction of reactant mixtures from the fuel cells in the fuel cell stack in the more mechanically stable metal-sheet recombination cell, possible damage to the subsequent membrane recombination fuel cell can be prevented.

The object directed to a method for treating hydrogen-containing and oxygen-containing residual gases from fuel cells is achieved by a method in which the residual gases from fuel cells amalgamated electrically and mechanically in a fuel cell stack are supplied to a recombination fuel cell which is led via a power circuit separate from the fuel cells.

Advantageously, the residual gases within the fuel cell stack are supplied to the recombination fuel cell.

Alternatively to this, it may be advantageous if the residual gases are led out of the fuel cell stack and supplied to a recombination fuel cell arranged outside the stack.

It is useful in this case if voltage and/or current strength of the recombination fuel cell is measured.

Advantageously, residual gases flow first through a metal-sheet recombination cell, in which a membrane of the recombination fuel cell is replaced by a metal sheet, before they are led into the recombination fuel cell.

With the invention, the recombination of the residual gases can be integrated directly in the construction of the fuel cell stack. Via the measurement of voltage and/or current, it is possible to measure the reactivity of the recombination cell, and no further gas sensors are required. A distinct geometrical advantage is obtained from integration into the fuel cell stack. Because of its construction, the recombination system can be optimally cooled. In certain cases, recovery of energy from the reactants would also be possible.

### BRIEF DESCRIPTION OF THE FIGURES

The invention is elucidated in more detail, illustratively, with reference to the drawings. Schematically and not to scale,

FIG. 1 shows a first fuel cell assembly according to the invention,

FIG. 2 shows a model construction of a PEM fuel cell,

FIG. 3 shows a second fuel cell assembly according to the invention, and

FIG. 4 shows a third fuel cell assembly according to the invention.

### DETAILED DESCRIPTION OF THE FIGURES

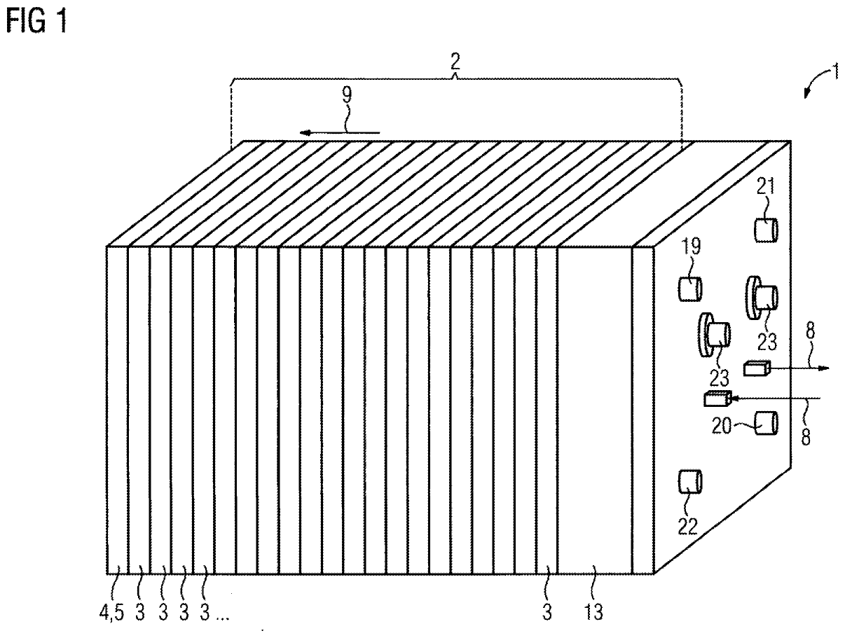

FIG. 1 shows in simplified representation a fuel cell assembly 1 which comprises a fuel cell stack 2 and an operating part 13. The fuel cell stack 2 consists of a plurality of individual fuel cells 3, here PEM fuel cells, which are stacked atop one another and thereby connected electrically in series.

Additionally, FIG. 1 shows a residual gas treatment device 4 of the invention for hydrogen-containing and oxygen-containing residual gases of the fuel cells 3 of the fuel cell stack 2. This residual gas treatment device 4 comprises a recombination fuel cell 5, the model construction of which is no different from that of a fuel cell 3 of the fuel cell stack 2. In terms of a flow direction 9 of the reactants, the recombination fuel cell 5 is downstream of the fuel cells 3, but is not connected electrically in series with them, being instead routed via a power circuit 8 separate from the fuel cells 3.

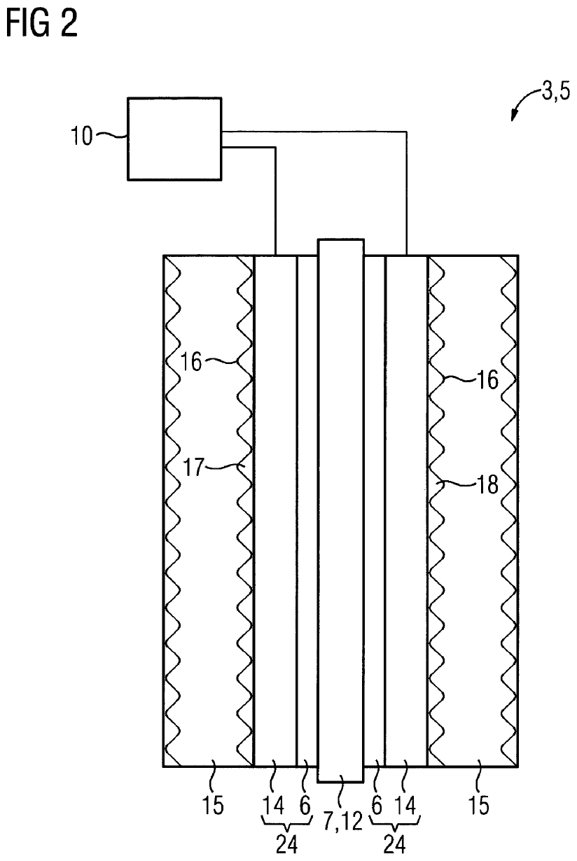

FIG. 2 shows in simplified form, in section, the fuel cell construction. Each of the fuel cells 3 and recombination fuel cells 5 has a membrane 7 and on either side thereof a catalyst layer 6 and a gas diffusion layer 14. Gas diffusion layer 14 and catalyst layer 6 together form a gas diffusion electrode 24. This is adjoined by a bipolar plate 15, which produces the electrical connection to the adjacent fuel cell 3 and accommodates gas distributor structures 16 which form gas spaces 17 and 18 for the hydrogen and oxygen reactants. The electrode 24 at a gas space 17 for hydrogen is also called the anode, and the electrode 24 at a gas space 18 for oxygen is also called the cathode. Channels for supplying and discharging the reactants to and from the fuel cells, and seals, etc., are not shown, in order to simplify the representation.

The operating part 13 of the fuel cell assembly 1 comprises technical connections, sensors, valves, water separators, etc. Hence there are connections for the supply 19 and discharge 20 of hydrogen, and connections for the supply 21 and discharge 22 of oxygen. Moreover, at the operating-part end of the fuel cell assembly 1, electrical load connections 23 are routed outward, allowing connection thereto of a load (not represented) to be fed with power from the fuel cell assembly 1. In the exemplary embodiment of FIG. 1, in the flow direction 9 of the reactants, the recombination fuel cell 5 is directly downstream of the fuel cells 3 in the fuel cell stack 2, thereby achieving a compact construction.

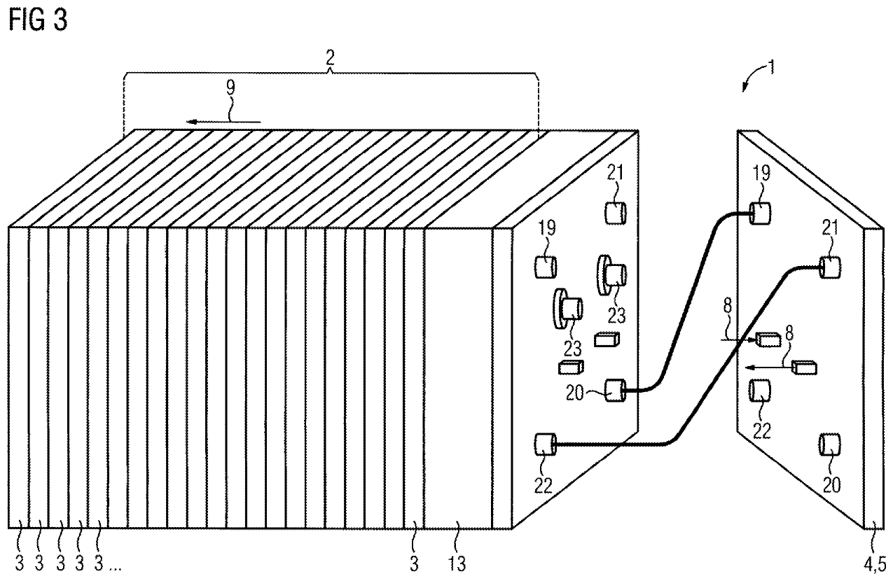

FIG. 3 shows an alternative embodiment of a fuel cell assembly 1 according to the invention, in which, in the flow direction 9 of the reactants, the recombination fuel cell 5 is downstream of the fuel cells 3 outside the fuel cell stack 2.

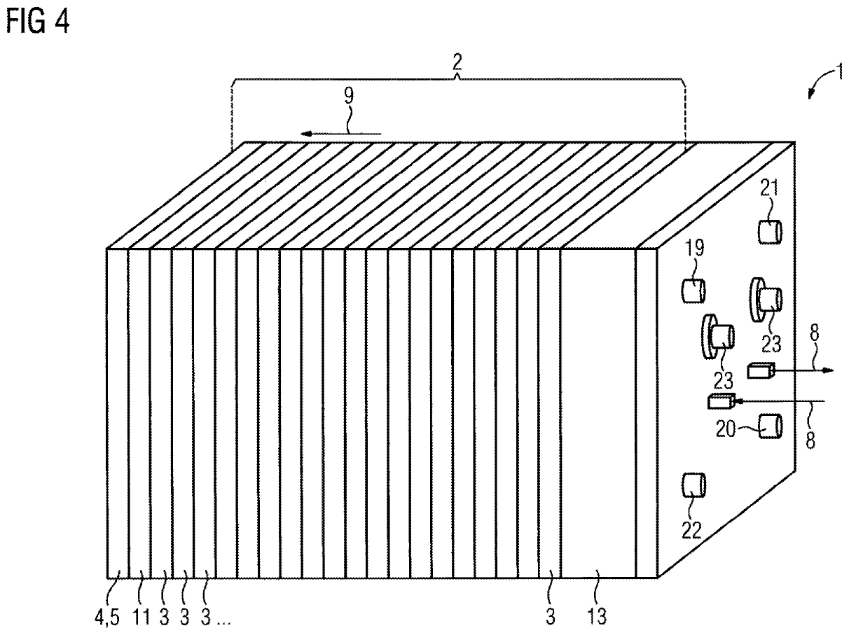

According to one development of the invention, a measuring device 10 for voltage and/or current is integrated into the recombination fuel cell 5 (see FIG. 2). In the exemplary embodiments of FIGS. 1 and 4, corresponding connections for the power circuit 8 are arranged in the region of the rest of the connections. In FIG. 3 there are corresponding connections on the external recombination fuel cell 5.

Relative to the exemplary embodiment of FIG. 1, the fuel cell assembly of FIG. 4 has been altered by the arrangement of a metal-sheet recombination cell 11 between the fuel cells 3 and the recombination fuel cell 5. The construction of such a metal-sheet recombination cell 11 differs from that of the recombination fuel cell 5 in that the membrane 7 of the recombination fuel cell 5 is replaced by a metal sheet 12, which increases the mechanical stability relative to the recombination fuel cell 5 and which allows the mechanical/thermal stress arising from the reaction of hydrogen with oxygen to occur already within this cell, without damaging it, and therefore allows possible damage to the subsequent recombination fuel cell 5 to be prevented.

1. A fuel cell assembly comprising a plurality of fuel cells amalgamated electrically and mechanically in a fuel cell stack, further comprising a residual gas treatment device for hydrogen-containing and oxygen-containing residual gases of the fuel cells, characterized in that the residual gas treatment device comprises a recombination fuel cell with catalyst and membrane that is led via a power circuit separate from the fuel cells.

2. The fuel cell assembly as claimed in claim 1, wherein the recombination fuel cell is directly downstream of the fuel cells in the fuel cell stack.

3. The fuel cell assembly as claimed in claim 1, wherein the recombination fuel cell is downstream of the fuel cells outside the fuel cell stack.

4. The fuel cell assembly as claimed in claim 1, wherein a measuring device for voltage and/or current is integrated into the recombination fuel cell or connected to the recombination fuel cell.

5. The fuel cell assembly as claimed in claim 1, wherein a metal-sheet recombination cell is arranged between the fuel cells and the recombination fuel cell, the membrane of the recombination fuel cell being replaced in the metal-sheet recombination cell by a metal sheet.

6. A method for treating hydrogen-containing and oxygen-containing residual gases from fuel cells, in which the residual gases from fuel cells amalgamated electrically and mechanically in a fuel cell stack are supplied to a recombination fuel cell which is led via a power circuit separate from the fuel cells.

7. The method as claimed in claim 6, wherein the residual gases within the fuel cell stack are supplied to the recombination fuel cell.

8. The method as claimed in claim 6, wherein the residual gases are led out of the fuel cell stack and supplied to the recombination fuel cell.

9. The method as claimed in claim 6, wherein voltage and/or current strength of the recombination fuel cell is measured.

10. The method as claimed in claim 6, wherein residual gases flow first through a metal-sheet recombination cell in which instead of a membrane, as in the recombination fuel cell, a metal sheet is arranged, before they are led into the recombination fuel cell.
